(19) United States
(12) Patent Application Publication
(10) Pub. No.: US 2026/0280202 A1
(43) Pub. Date: Sep. 17, 2026

(54) COAXIAL ELECTRICAL CONNECTOR AND ELECTRICAL CONNECTOR ASSEMBLY

(71) Applicant: Hirose Electric Co., Ltd., Yokohama (JP)

(72) Inventors: Tsuyoshi NAKAGAWA, Yokohama (JP); Satoru AIHARA, Yokohama (JP)

(21) Appl. No.: 19/307,842

(22) Filed: Aug. 22, 2025

(30) Foreign Application Priority Data
Aug. 30, 2024 (JP) 2024-148432

(51) Int. Cl. H01R 24/38

(52) U.S. Cl. CPC H01R 24/38

(57) ABSTRACT

A resilient body can apply a resilient force adapted to bring a coupling member to a neutral position between an advanced position and a retracted position to a front pressure-applying portion and rear pressure-applying portion; the coupling member has an intermediate protrusion protruding from the inner peripheral surface of said coupling member and forms a front space forwardly of the intermediate protrusion between itself and the outer peripheral surface of a shell member while forming a rear space rearwardly of the intermediate protrusion between itself and the outer peripheral surface of the shell member; and ball members are restricted in movement in the front-rear direction by the inner peripheral edges of holes while being movable in the radial direction of the connector, and are capable of lockingly engaging a locking engagement portion provided in a counterpart connector via portions protruding radially inwardly from the holes.

### CROSS-REFERENCE TO RELATED APPLICATIONS

This application claims priority to Japanese Patent Application No. 2024-148432, filed Aug. 30, 2024, the contents of which are incorporated herein by reference in its entirety for all purposes.

### BACKGROUND

### Field

The present disclosure relates to a coaxial electrical connector and an electrical connector assembly having said coaxial electrical connector.

### Related Art

Patent Document 1 has disclosed a coaxial electrical connector that has an axis extending in the front-rear direction and is matingly connected to a counterpart connector such that the direction of this axis is the direction of connection. As referred to herein, the direction of mated connection to a counterpart connector is “forward,” and the direction of decoupling from a counterpart connector is “rearward.” The coaxial electrical connector is fitted over a counterpart connector and is thus matingly connected thereto.

The coaxial electrical connector of Patent Document 1 has a tubular member, an external contact and an insulating spacer retained by the inner peripheral surface of the tubular member, and a male contact retained by said insulating spacer. An inner sleeve, a compression spring, and a securing barrel portion are fitted over the tubular member and, furthermore, an outer sleeve is fitted over these components. In addition, a receiving barrel portion is fitted within the front end portion of the outer sleeve.

A plurality of ball accommodating holes is formed in the circumferential direction in the front end portion of the tubular member, and an engagement ball is accommodated in each ball accommodating hole. The ball accommodating holes are formed passing through the tubular member in the radial direction while extending in the front-rear direction. Accordingly, the engagement balls are capable of movement in the radial direction as well as in the front-rear direction. In addition, the engagement balls have portions thereof protruding radially inwardly from the ball accommodating holes.

When an operation is initiated to connect the coaxial electrical connector to a counterpart connector, the rear end portion of the counterpart connector abuts the protruding portions of the engagement balls (see FIG. 3 in Patent Document 1). Next, as a result of having the protruding portions thereof pressed against the rear end portion of the counterpart connector, the engagement balls move rearwardly through the ball accommodating holes while compressing the compression spring (see FIG. 4 in Patent Document 1).

Thereafter, the engagement balls, pressed against the outer peripheral surface of the counterpart connector, move outwardly in the radial direction (see FIG. 5 in Patent Document 1) and furthermore, pressed against the inner sleeve under the resilient force of the compression spring, move forward through the ball accommodating holes (see FIG. 6 in Patent Document 1). Then, the engagement balls, pressed against the inner peripheral surface of the outer sleeve, move inwardly in the radial direction and, while being supported by said inner peripheral surface, enter into engagement with an engagement recess in the counterpart connector via the portions protruding from the ball accommodating holes (see FIG. 6 in Patent Document 1). This brings the two connectors into mated connection.

In addition, when the coaxial electrical connector is pulled rearward during connector decoupling, the outer sleeve moves rearwardly and a space is formed radially outside of the engagement balls. At this time, the engagement balls are subject to a force having a component directed radially outwardly from the edges of the engagement recess of the counterpart connector and move outwardly in the radial direction (see FIG. 7 in Patent Document 1). As a result, the engagement balls and the engagement recess are released from engagement, and the coaxial electrical connector can consequently be decoupled from the counterpart connector by pulling the connector rearwardly “as-is” (see FIG. 8 in Patent Document 1).

### PATENT DOCUMENTS

### Patent Document 1

Japanese Patent Application Publication No. 2011-228212.

### SUMMARY

### Problems to be Solved

It is an object of the present disclosure to provide a coaxial electrical connector and a connector assembly in which a size increase in the direction of connection of the connectors can be avoided in an adequate manner. As discussed previously, in the coaxial electrical connector of Patent Document 1, during the engagement and disengagement of the two connectors, the engagement balls move through the ball accommodating holes not only in the radial direction, but also in the front-rear direction (in the direction of connection of the connectors). Accordingly, in the coaxial electrical connector, the ball accommodating holes are formed of dimensions corresponding to the distance traveled by the engagement balls in the front-rear direction. There is a risk that shaping the ball accommodating holes to extend in the front-rear direction in this manner could cause an increase in the size of the coaxial electrical connector in the front-rear direction.

With such circumstances in mind, it is an object of the present invention to provide a coaxial electrical connector and a connector assembly in which a size increase in the direction of connection of the connectors can be avoided in an adequate manner.

### Technical Solution

(1) The inventive coaxial electrical connector, which is a coaxial electrical connector having an axis extending in the front-rear direction and matingly connected to a counterpart connector in the forward direction, comprises a shell member having a tubular shape extending in the front-rear direction and having at least one hole formed passing therethrough in the radial direction; an outer conductor, a dielectric body, and a center conductor provided within the shell member; a coupling member fitted over the shell member and capable of relative movement with respect to the shell member in the front-rear direction between an advanced position and a retracted position; and ball members accommodated in the holes.

In the present invention, such a coaxial electrical connector is characterized by having a resilient body which is accommodated in an accommodating space formed between the outer peripheral surface of the shell member and the inner peripheral surface of the coupling member at a location different from the ball members in the front-rear direction and which is capable of expansion and compression in the front-rear direction; a front support portion capable of supporting the resilient body from the front and a rear support portion capable of supporting the resilient body from the rear, which are provided in the shell member; and a front pressure-applying portion capable of applying pressure to the resilient body from the front and a rear pressure-applying portion capable of applying pressure to the resilient body from the rear, which are provided in the coupling member; and by the fact that the resilient body is capable of applying a resilient force adapted to bring the coupling member to a neutral position between the advanced position and the retracted position to the front pressure-applying portion and the rear pressure-applying portion; the coupling member has a protrusion protruding from the inner peripheral surface of said coupling member and forms a front space forwardly of the protrusion between itself and the outer peripheral surface of the shell member while forming a rear space rearwardly of the protrusion between itself and the outer peripheral surface of the shell member; the ball members are restricted in movement in the front-rear direction by the inner edges or inner surfaces of the holes while being movable in the radial direction, and are lockingly engageable with a locking engagement portion provided in the counterpart connector via the portions protruding radially inwardly from the holes; and, when the coupling member is in the neutral position, the protrusion is positioned in alignment with the ball members in the front-rear direction, which restricts radially outwardly directed movement of the ball members; when the coupling member is in the advanced position, the rear space is positioned in alignment with the ball members in the front-rear direction, which permits radially outwardly directed movement of the ball members; and, when the coupling member is in the retracted position, the front space is positioned in alignment with the ball members in the front-rear direction, which permits radially outwardly directed movement of the ball members.

In the present invention, when the coaxial electrical connector is connected to the counterpart connector, the coaxial electrical connector is mated with the counterpart connector by moving the coupling member of the coaxial electrical connector forward while holding it with one's fingers, etc. When the operation of mating connection is initiated, the rear end portion of the counterpart connector first abuts portions of the ball members (the parts protruding radially inwardly from the holes) from the front. At this time, the coupling member is in the neutral position, and the ball members are therefore restricted in movement in the front-rear direction by the inner edges or inner surfaces of the holes while being restricted in radially outward movement by the protrusion of the coupling member. Accordingly, with the rear end portion of the counterpart connector kept in abutment against the ball members, the coupling member is brought to the advanced position via relative movement with respect to the shell member in the forward direction. At this time, the resilient body is subjected to pressure by the rear pressure-applying portion from the rear while being supported by the front support portion from the front, and is thus brought into a compressed state.

When the coupling member is brought to the advanced position, the rear space formed between said coupling member and the shell member is positioned in alignment with the ball members in the front-rear direction. Accordingly, radially outwardly directed movement of the ball members is permitted by the rear space. Then, the ball members, pressed against the rear end portion of the counterpart connector, move outwardly in the radial direction, thereby making advancement of the coaxial electrical connector possible. When the coaxial electrical connector advances further and reaches the regular mating position, the ball members are positioned in alignment with the locking engagement portion of the counterpart connector in the front-rear direction. As a result, the ball members move inwardly in the radial direction and portions thereof protrude from the holes. The protruding portions of the ball members then lockingly engage the locking engagement portion in the front-rear direction.

Next, when one's fingers are removed from the coupling member, the resilient body is released from the compressed state and the coupling member is consequently returned to the neutral position via rearward movement under the resilient force of the resilient body. When the coupling member is returned to the neutral position, radially outwardly directed movement of the ball members is restricted by the protrusion of the coupling member. As a result, the state of locked engagement between the protruding portions of the ball members and the locking engagement portion is maintained, and the operation of mating connection of the two connectors is completed.

In addition, when the coaxial electrical connector is decoupled from the counterpart connector, the coaxial electrical connector is pulled rearwardly while the coupling member of the coaxial electrical connector is held with one's fingers, etc. In a state of mated connection, the protruding portions of the ball members are in locked engagement with the locking engagement portion as described above. Accordingly, when the decoupling operation is initiated, the coupling member is first brought to the retracted position via relative movement with respect to the shell member in the rearward direction. When the coupling member is brought to the retracted position, the front space formed between said coupling member and the shell member is positioned in alignment with the ball members in the front-rear direction, thereby permitting radially outwardly directed movement of the ball members. Further, when the ball members move outwardly in the radial direction under the force pulling the coaxial electrical connector rearward, the ball members and locking engagement portion are released from locked engagement, which makes further rearward movement of the coaxial electrical connector possible. Accordingly, the coaxial electrical connector is decoupled from the counterpart connector by pulling the coaxial electrical connector rearwardly “as-is.”

Thus, in the present invention, during the operation of mating connection and the operation of decoupling of the two connectors, the ball members are adapted to move in the radial direction alone, without moving in the front-rear direction. Accordingly, there is no need to form the holes of a shape elongated in the front-rear direction to permit movement of the ball members in the front-rear direction, as was done in the prior art, and an increase in the size of the shell member and, by extension, the coaxial electrical connector, in the front-rear direction can therefore be avoided better than in the prior art.

(2) In the invention of (1), when the coupling member is in the neutral position, the front support portion and front pressure-applying portion may have both rear faces thereof aligned in the front-rear direction and make contact with the resilient body from the front via the respective rear faces, and the rear support portion and rear pressure-applying portion may have both front faces thereof aligned in the front-rear direction and make contact with the resilient body from the rear via the respective front faces.

In such a configuration, when the coupling member is in the neutral position, the rear faces of both the front support portion and front pressure-applying portion make contact with the resilient body from the front, and the front faces of both the rear support portion and rear pressure-applying portion make contact therewith from the rear. Accordingly, the resilient body is supported by a sufficiently large area of contact from the front and from the rear, and said coupling member can therefore be maintained in the neutral position in an adequate manner.

(3) In the inventions of (1) or (2), the shell member may have an abutment portion protruding from the outer peripheral surface of the shell member within the bounds of the accommodating space in the front-rear direction, and the abutment portion may abut the rear portion of the resilient body subjected to pressure by the rear pressure-applying portion from the front when the coupling member is in the advanced position and may abut the front portion of the resilient body subjected to pressure by the front pressure-applying portion from the rear when the coupling member is in the retracted position.

In this manner, the abutment portion abuts the rear portion of the resilient body in the advanced position and abuts the front portion of the resilient body in the retracted position, thereby keeping the extent of compression of the resilient body and, in turn, the extent of movement of the coupling member in the front-rear direction within a predetermined range. As a result, the operating range of the connectors during the engagement and disengagement of the connectors in the front-rear direction can be reduced.

(4) In any of the inventions of (1) through (3), the rear pressure-applying portion may be provided in a member that is fitted over the shell member while being attached to the coupling member from the rear.

(5) In any of the inventions of (1) through (4), the front end of the shell member may be aligned with the front end of the coupling member or located rearwardly of said front end when said coupling member is in the neutral position. With such a configuration, the front end of the shell member has to be located within the bounds of the coupling member in the front-rear direction when the coupling member is in the neutral position, and an increase in the size of the coaxial electrical connector in the front-rear direction can therefore be avoided in an adequate manner.

(6) The inventive electrical connector assembly is characterized by having any of the coaxial electrical connectors of (1) through (5) and a counterpart connector matingly connected to said coaxial electrical connector.

### Technical Effect

The present invention can provide a coaxial electrical connector and a connector assembly in which a size increase in the direction of connection of the connectors can be avoided in an adequate manner.

### BRIEF DESCRIPTION OF THE DRAWINGS

FIG. 1 illustrates a perspective view of an embodiment of the electrical connector assembly showing a state prior to mating connection of the two connectors, as viewed obliquely from the front.

FIG. 2 illustrates a perspective view of an embodiment of the electrical connector assembly showing a state prior to mating connection of the two connectors, as viewed obliquely from the rear.

FIG. 3 illustrates a longitudinal cross-sectional view of an embodiment of the electrical connector assembly taken in a plane containing the axis, showing a state prior to mating connection of the two connectors.

FIG. 4 illustrates a longitudinal cross-sectional view of an embodiment of the electrical connector assembly taken in a plane containing the axis, showing a state wherein the two connectors are in the process of mating connection.

FIG. 5 illustrates a longitudinal cross-sectional view of an embodiment of the electrical connector assembly taken in a plane containing the axis, showing a state wherein the two connectors are in the process of mating connection.

FIG. 6 illustrates a longitudinal cross-sectional view of an embodiment of the electrical connector assembly taken in a plane containing the axis, showing a state wherein the two connectors are in the process of mating connection.

FIG. 7 illustrates a longitudinal cross-sectional view of an embodiment of the electrical connector assembly taken in a plane containing the axis, showing a state wherein the two connectors are in the process of mating connection.

FIG. 8 illustrates a longitudinal cross-sectional view of an embodiment of the electrical connector assembly taken in a plane containing the axis, showing a state of mated connection of the two connectors.

FIG. 9 illustrates a longitudinal cross-sectional view of an embodiment of the electrical connector assembly taken in a plane containing the axis, showing a state wherein the two connectors are in the process of decoupling.

FIG. 10 illustrates a longitudinal cross-sectional view of an embodiment of the electrical connector assembly taken in a plane containing the axis, showing a state wherein the two connectors are in the process of decoupling.

FIG. 11 illustrates a longitudinal cross-sectional view of an embodiment of the electrical connector assembly taken in a plane containing the axis, showing a state wherein the two connectors are in the process of decoupling.

FIG. 12 illustrates a longitudinal cross-sectional view of an embodiment of the coaxial electrical connector according to a variation, taken in a plane containing the axis.

### DETAILED DESCRIPTION

Embodiments of the present invention will be explained hereinbelow with reference to the accompanying drawings.

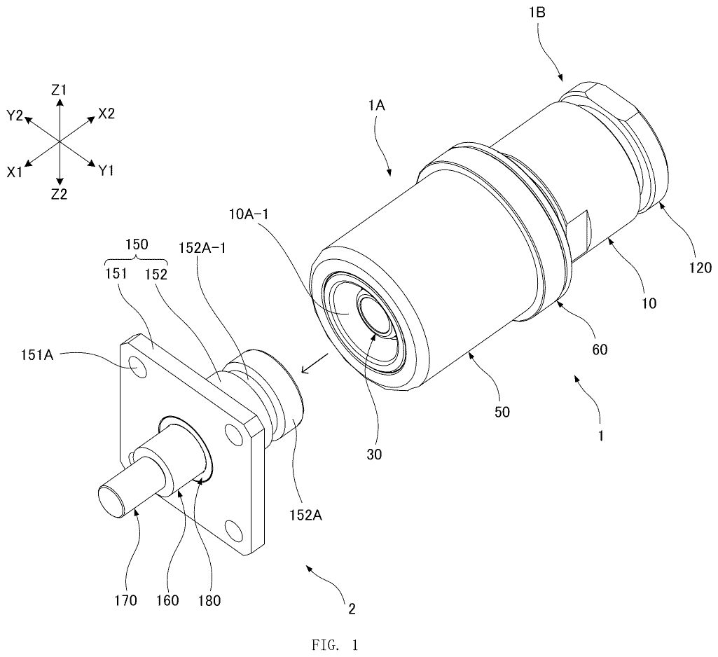

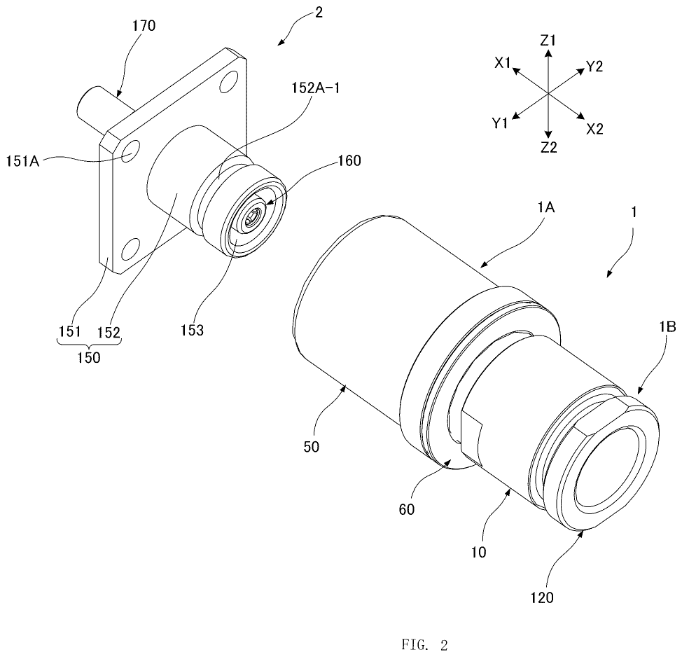

The electrical connector assembly of the present embodiment, as shown in FIG. 1 and FIG. 2, has a coaxial electrical connector 1 (hereinafter referred to as “connector 1”) and a counterpart connector 2, which is a counterpart coaxial electrical connector to which the connector 1 is matingly connected. The connector 1 is matingly connected to the counterpart connector 2 in the forward direction (X1 direction) such that the front-rear direction (X-axis direction) is the direction of mating. In the present embodiment, a front end section of a cable (not shown) extending in the front-rear direction is connected to the connector 1. In addition, the counterpart connector 2 is screw-attached to a housing (not shown) of an electronic device. It should be noted that the Y-axis direction and Z-axis direction illustrated in FIG. 1 and in FIG. 2 are examples of the radial direction of the connector 1.

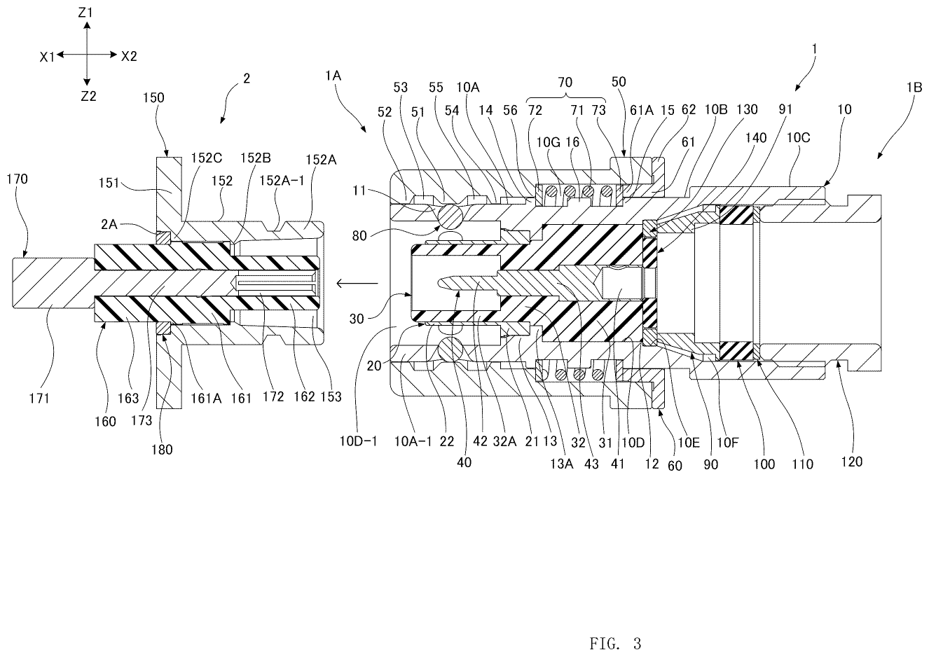

As shown in FIG. 1 through FIG. 3, the connector 1 has a connector main body 1A, a cable attachment portion 1B for attaching a cable to the connector main body 1A, and an intervening ring 130 (see FIG. 3) and an intervening washer 140 (see FIG. 3) interposed between the connector main body 1A and the cable attachment portion 1B. The connector main body 1A, cable attachment portion 1B, intervening ring 130, and intervening washer 140 have the same axis extending in the front-rear direction and are provided concentrically along said axis.

As shown in FIG. 3, the connector main body 1A has a shell member 10, an outer conductor 20, a dielectric body 30, a center conductor 40, a coupling member 50, a rear pressure-applying member 60, a resilient body 70, and ball members 80.

The shell member 10 is a metal member of a generally tubular shape extending in the front-rear direction. As shown in FIG. 3, the shell member 10 has a front barrel portion 10A serving as a front portion, an intermediate barrel portion 10B serving as an intermediate portion in the front-rear direction, and a rear barrel portion 10C serving as a rear portion. The intermediate barrel portion 10B is formed of a larger outside diameter than the front barrel portion 10A. In addition, the rear barrel portion 10C is formed of a larger outside diameter than the front barrel portion 10A and the intermediate barrel portion 10B. A thread groove (not shown) used for attaching the cable attachment portion 1B is formed in the inner peripheral surface of the rear portion of the rear barrel portion 10C.

The front portion of the front barrel portion 10A, specifically, the part located forwardly of the hereinafter described positioning portion 13, serves as an outer mating portion 10A-1 used for mating with the counterpart connector 2. A plurality of holes 11 passing through the outer mating portion 10A-1 in the radial direction are formed in said outer mating portion 10A-1. The holes 11 are formed at equal intervals at a plurality of locations in the circumferential direction of the front barrel portion 10A. Each hole 11 accommodates a ball member 80. The holes 11 form generally frustoconical spaces that get narrower as one moves inwardly in the radial direction, and the inner surfaces of said holes 11 have a generally tapered configuration.

The interior space of the shell member 10 has three spaces placed in communication with one another in the front-rear direction, specifically, a front interior space 10D, an intermediate interior space 10E, and a rear interior space 10F. The front interior space 10D is formed within a range extending from the location of the front end of the front barrel portion 10A to an intermediate location of the intermediate barrel portion 10B in the front-rear direction. In the front interior space 10D, the space forming the interior space of the outer mating portion 10A-1 is formed as a receiving space 10D-1 used for receiving a portion of the counterpart connector 2 from the front. The intermediate interior space 10E is located at the rear of the front interior space 10D and is formed within the bounds of a portion of the intermediate barrel portion 10B in the front-rear direction. The rear interior space 10F is located at the rear of the intermediate interior space 10E and is formed within a range extending from the location of the rear end of the intermediate interior space 10E to the location of the rear end of the rear barrel portion 10C in the front-rear direction.

The intermediate interior space 10E is formed of a larger size in the radial direction than the front interior space 10D. The rear interior space 10F is formed of a larger size in the radial direction than the front interior space 10D and intermediate interior space 10E. A stepped portion 12 is formed in the inner peripheral surface of the shell member 10 at the location of the boundary between the front interior space 10D and intermediate interior space 10E, in other words, at the location of the rear end of the front interior space 10D. In addition, within the range corresponding to the front portion of the rear interior space 10F, the inner peripheral surface of the shell member 10 has a tapered configuration inclined outwardly in the radial direction as one moves rearward.

As shown in FIG. 3, the front interior space 10D accommodates the outer conductor 20, dielectric body 30, and center conductor 40. The intermediate interior space 10E accommodates the intervening ring 130 and intervening washer 140. The rear interior space 10F accommodates a portion of the cable attachment portion 1B.

The front barrel portion 10A has provided therein a positioning portion 13 protruding from the inner peripheral surface at an intermediate location in the front-rear direction while extending throughout the entire circumference. The positioning portion 13 abuts the outer conductor 20 and dielectric body 30 and thus positions said outer conductor 20 and said dielectric body 30 in the front-rear direction. A small protrusion 13A protruding farther inwardly in the radial direction than other portions is formed in the rear portion of the positioning portion 13.

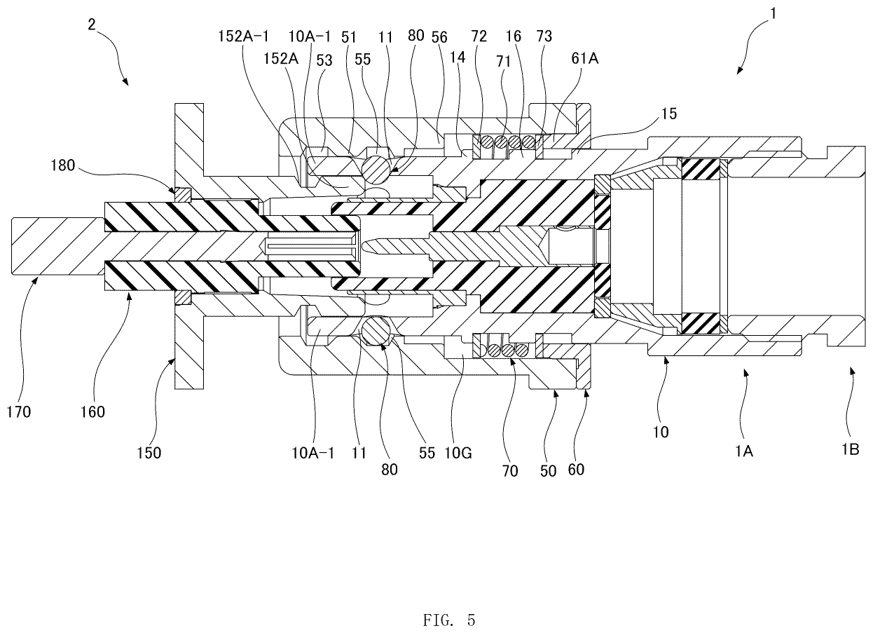

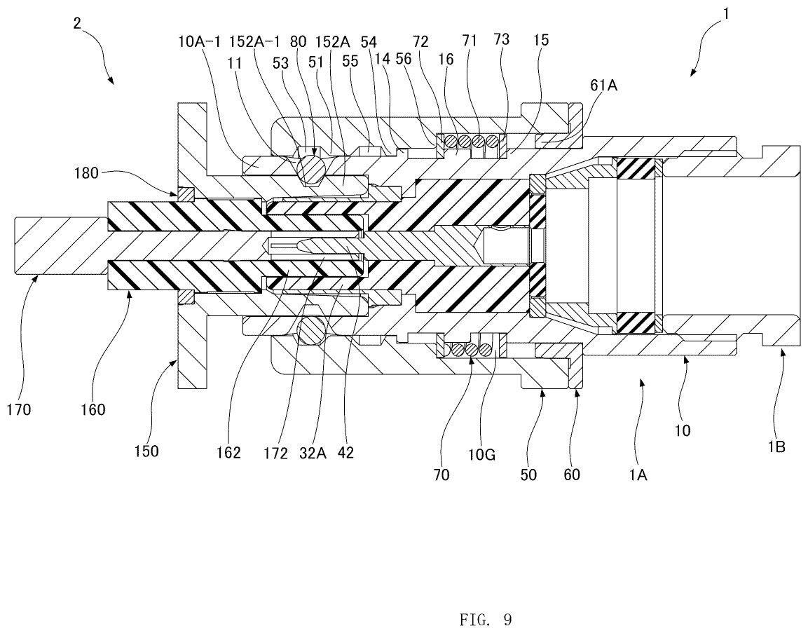

A front support portion 14, a rear support portion 15, and an abutment portion 16 are provided in the outer peripheral surface of the shell member 10. The front support portion 14 is a part capable of supporting the resilient body 70 from the front, and the rear support portion 15 is a part capable of supporting the resilient body 70 from the rear. As described below, the abutment portion 16 is a part capable of abutting, from the front or from the rear, the resilient body 70 when the latter is compressed to the full extent as the coupling member 50 moves in the front-rear direction (for example, see FIG. 5 and FIG. 9, etc.).

As shown in FIG. 3, the front support portion 14 protrudes from the outer peripheral surface of the shell member 10 while extending throughout the entire circumference at a location within the bounds of the positioning portion 13 in the front-rear direction. The rear support portion 15, which is formed in the front end portion of the intermediate barrel portion 10B rearwardly of the front support portion 14 and abutment portion 16, has a stepped configuration at the location of the boundary with the front barrel portion 10A. The abutment portion 16, which is located between the front support portion 14 and rear support portion 15 in the front-rear direction, protrudes from the outer peripheral surface of the shell member 10 while extending throughout the entire circumference. In the present embodiment, the abutment portion 16 is provided at a central location between the front support portion 14 and rear support portion 15 in the front-rear direction. Accordingly, in the front-rear direction, the distance between the rear support portion 15 and abutment portion 16 is equal to the distance between the front support portion 14 and abutment portion 16.

As shown in FIG. 3, the outer conductor 20, which is a metal member of a generally tubular shape extending in the front-rear direction, is accommodated in the front interior space 10D of the shell member 10. The outer conductor 20 has a rear portion 21, which is formed with thicker walls in the radial direction, and a front portion 22, which extends forward from the rear portion 21 and is formed with thinner walls in the radial direction than the rear portion 21. The rear portion 21 is located within the bounds of the positioning portion 13 of the shell member 10 in the front-rear direction, with the rear face thereof making surface contact with the front face of the small protrusion 13A from the front. The front portion 22 is located within the receiving space 10D-1 of the shell member 10 in the front-rear direction.

As shown in FIG. 3, the dielectric body 30, which is a member made of plastic or another electrically insulating material having a generally tubular shape extending in the front-rear direction, is accommodated in the front interior space 10D of the shell member 10 while being retained by the shell member 10 and outer conductor 20. The dielectric body 30 has a rear portion 31, which is located rearwardly of the positioning portion 13 of the shell member 10, and a front portion 32, which extends forward from the rear portion 31. The front portion 32 is formed to be smaller in the radial direction than the rear portion 31.

The rear portion 31 is press-fittingly retained by the inner peripheral surface of the shell member 10. The front portion 32 is press-fittingly retained by the inner peripheral surface of the small protrusion 13A of the shell member 10 and the inner peripheral surface of the outer conductor 20. The dielectric body 30 makes surface contact with the positioning portion 13 and outer conductor 20 from the rear via a plurality of stepped portions formed in the outer peripheral surface, and is thereby positioned in the front-rear direction. The rear end face of the rear portion 31 is in the same position in the front-rear direction as the rear end of the front interior space 10D. A part of the front portion 32 projects into the receiving space 10D-1 and serves as an inner mating portion 32A used for mating with the counterpart connector 2. The interior space of the inner mating portion 32A, which is formed of a larger size in the radial direction than the interior space of other portions in the dielectric body 30, forms part of the receiving space 10D-1.

The center conductor 40, which is a metal member extending in the front-rear direction, is accommodated in the interior space of said dielectric body 30 while being retained by the dielectric body 30. The center conductor 40 has a connecting portion 41 provided at the rear end, a male-type contact portion 42 of a pin-like configuration provided at the front end, and a joining portion 43 provided at an intermediate location and joining the connecting portion 41 and contact portion 42. The connecting portion 41 is hollow, and the contact portion 42 and joining portion 43 are solid.

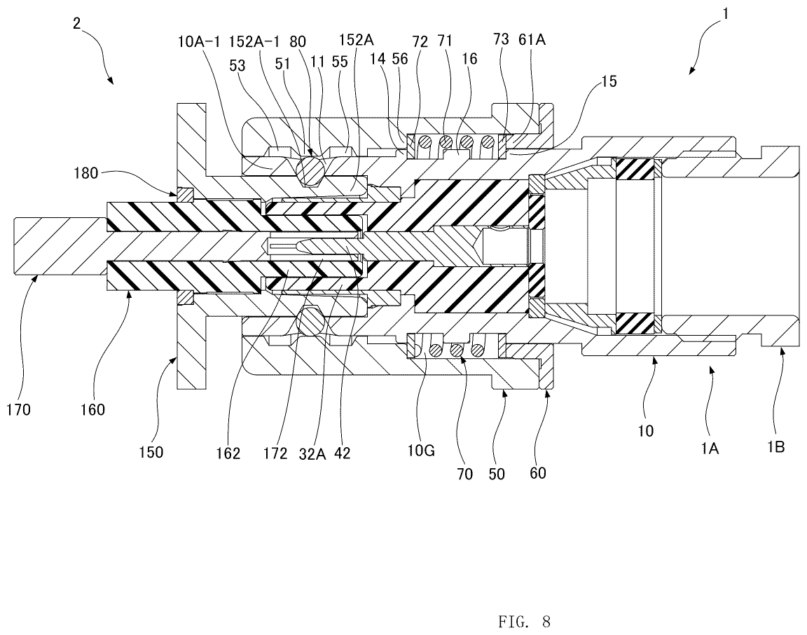

The connecting portion 41 is adapted to have connected thereto a core wire of a cable (not shown) inserted from the rear. The contact portion 42, which is accommodated in the interior space of the inner mating portion 32A of the dielectric body 30 while projecting thereinto, is capable of making contact with a counterpart center conductor 170 provided in the counterpart connector 2 (see FIG. 8). The connecting portion 41 and joining portion 43 are press-fittingly retained by the inner peripheral surface of the dielectric body 30. In addition, the center conductor 40 makes surface contact with a stepped portion formed in the inner peripheral surface of the dielectric body 30 from the rear via a stepped portion formed in the outer peripheral surface of the joining portion 43, and is thereby positioned in the front-rear direction. The rear end of the connecting portion 41 is in the same position in the front-rear direction as the rear end of the front interior space 10D.

The coupling member 50, which is a metal member of a generally tubular shape extending in the front-rear direction, is provided fitted over the shell member 10. The coupling member 50 is capable of relative movement with respect to the shell member 10 in the front-rear direction between the advanced position (see FIG. 5 through FIG. 7) and the retracted position (see FIG. 9 through FIG. 11). The coupling member 50 is located in the neutral position (see FIG. 3 and FIG. 8) when subject to no external forces.

As shown in FIG. 3, when the coupling member 50 is in the neutral position, the front end of the coupling member 50 is aligned with the front end of the shell member 10 in the front-rear direction. Namely, the front end of the shell member 10 is located within the bounds of the coupling member 50 in the front-rear direction, and an increase in size of the connector 1 in the front-rear direction can therefore be avoided in an adequate manner. While in the present embodiment the front end of the coupling member 50 and the front end of the shell member 10 are aligned, as an alternative, the front end of the shell member may be adapted to be located rearwardly of the front end of the coupling member when the coupling member is in the neutral position.

An intermediate protrusion 51, a front protrusion 52, and a rear protrusion 54 are formed in the front portion of the coupling member 50 as protrusions protruding from the inner peripheral surface while extending throughout the entire circumference. As shown in FIG. 3, the intermediate protrusion 51 protrudes such that its dimensions in the front-rear direction are reduced as one moves inwardly in the radial direction, and its cross-section perpendicular to the circumferential direction has a generally trapezoidal configuration. The front face of the intermediate protrusion 51 is an inclined surface inclined rearward as one moves inwardly in the radial direction. The rear face of the intermediate protrusion 51 is an inclined surface inclined forward as one moves inwardly in the radial direction.

As shown in FIG. 3, the front protrusion 52, which is located forwardly of the intermediate protrusion 51 in a spaced-apart relationship from said intermediate protrusion 51, forms part of the front end portion of the coupling member 50. In addition, the front protrusion 52, which protrudes inwardly in the radial direction such that the extent of protrusion is slightly larger than that of the intermediate protrusion 51, has a protruding apical face located substantially in the same position in the radial direction as the outer peripheral surface of the shell member 10. As shown in FIG. 3, the front protrusion 52 protrudes such that its dimensions in the front-rear direction are reduced as one moves inwardly in the radial direction, and its cross-section perpendicular to the circumferential direction has a generally trapezoidal configuration. The front face of the front protrusion 52 is a surface perpendicular to the front-rear direction, and the rear face of the front protrusion 52 is an inclined surface inclined forward as one moves inwardly in the radial direction.

In addition, a front space 53 is formed between the intermediate protrusion 51 and front protrusion 52 in the front-rear direction as well as between the inner peripheral surface of the coupling member 50 and the outer peripheral surface of the shell member 10 in the radial direction.

As shown in FIG. 3, the rear protrusion 54 is located rearwardly of the intermediate protrusion 51 in a spaced-apart relationship from said intermediate protrusion 51. The rear protrusion 54, which protrudes inwardly in the radial direction such that the extent of protrusion is slightly larger than that of the intermediate protrusion 51, has a protruding apical face located substantially in the same position in the radial direction as the outer peripheral surface of the shell member 10. As shown in FIG. 3, the rear protrusion 54 protrudes such that its dimensions in the front-rear direction are reduced as one moves inwardly in the radial direction, and its cross-section perpendicular to the circumferential direction has a generally trapezoidal configuration. The front face of the rear protrusion 54 is an inclined surface inclined rearward as one moves inwardly in the radial direction, and the rear face of the rear protrusion 54 is a surface perpendicular to the front-rear direction.

In addition, a rear space 55 is formed between the intermediate protrusion 51 and rear protrusion 54 in the front-rear direction as well as between the inner peripheral surface of the coupling member 50 and the outer peripheral surface of the shell member 10 in the radial direction.

The coupling member 50 has a stepped front pressure-applying portion 56 formed in the inner peripheral surface at the location of the boundary between the front portion and rear portion, and the inner peripheral surface of the rear portion is located radially outside of the inner peripheral surface of the front portion. In other words, in the coupling member 50, the interior space of the rear portion is larger in the radial direction than the interior space of the front portion. As shown in FIG. 3, when the coupling member 50 is in the neutral position, the rear face of the front pressure-applying portion 56 is in the same position in the front-rear direction as the rear face of the front support portion 14 of the shell member 10. At this time, the rear face of the front pressure-applying portion 56 and the rear face of the front support portion 14 make surface contact with the resilient body 70 from the front and support said resilient body 70. In addition, when the coupling member 50 is in the retracted position, the front pressure-applying portion 56 is adapted to be located rearwardly of the front support portion 14 and apply pressure to the resilient body 70 from the front (see FIG. 9 through FIG. 11).

As shown in FIG. 3, the rear end portion of the coupling member 50, which protrudes radially outwardly of the outer peripheral surfaces of other portions in the coupling member 50, is formed with thicker walls in the radial direction than said other portions.

The rear pressure-applying member 60, which is a metal member, is fitted over the shell member 10 while being fitted within and attached to the rear end portion of the coupling member 50 from the rear. The rear pressure-applying member 60 has a cylindrical tubular portion 61, which extends in the front-rear direction, and an overhang portion 62, which projects outwardly in the radial direction in the rear end portion of the tubular portion 61. A part of the tubular portion 61, excluding the above-mentioned rear end portion, is press-fitted into the rear end portion of the coupling member 50 and is located between the rear end portion of said coupling member 50 and the shell member 10 in the radial direction. The rear pressure-applying member 60 attached to the coupling member 50 in this manner is movable in the front-rear direction along with the coupling member 50. Namely, the rear pressure-applying member 60 is also capable of relative movement with respect to the shell member 10 in the front-rear direction.

The front end portion of the tubular portion 61 serves as a rear pressure-applying portion 61A capable of applying pressure to the resilient body 70 from the rear. As shown in FIG. 3, when the coupling member 50 is in the neutral position, the front face of the rear pressure-applying portion 61A is in the same position in the front-rear direction as the front face of the rear support portion 15 of the shell member 10. At this time, the front face of the rear pressure-applying portion 61A and the front face of the rear support portion 15 make surface contact with the resilient body 70 from the rear and support said resilient body 70. In addition, when the coupling member 50 is in the advanced position, the rear pressure-applying portion 61A is adapted to be located forwardly of the rear support portion 15 and apply pressure to the resilient body 70 from the rear (see FIG. 5 through FIG. 7).

As discussed previously, in the present embodiment, when the coupling member 50 is in the neutral position, the rear faces of both the front support portion 14 and front pressure-applying portion 56 are in surface contact with the resilient body 70 from the front, and the front faces of both the rear support portion 15 and rear pressure-applying portion 61A are in surface contact therewith from the rear. Accordingly, the resilient body 70 is supported by a sufficiently large area of contact from the front and from the rear, and the coupling member 50 can therefore be maintained in the neutral position in an adequate manner.

As shown in FIG. 3, an accommodating space 10G accommodating the resilient body 70 is formed between the rear portion of the coupling member 50 and the rear portion of the front barrel portion 10A of the shell member 10 in the radial direction. With the coupling member 50 located in the neutral position, the accommodating space 10G is formed in the front-rear direction between the front support portion 14 and front pressure-applying portion 56, on the one hand, and the rear support portion 15 and rear pressure-applying portion 61A, on the other hand.

The resilient body 70 has a spring member 71 capable of expansion and compression in the front-rear direction, a front ring 72 provided in front of the spring member 71, and a rear ring 73 provided at the rear of the spring member 71. The spring member 71 may be, for example, a coil spring having an axis extending in the front-rear direction. The outside diameter of the spring member 71 is slightly smaller than the inside diameter of the rear portion of the coupling member 50. The inside diameter of the spring member 71 is slightly larger than the outside diameter of the abutment portion 16 of the shell member 10. Accordingly, the spring member 71 does not interfere with the abutment portion 16 in the front-rear direction, and thus makes smooth expansion and contraction possible.

The front ring 72 and rear ring 73 may be, for example, C-rings made of sheet metal. The outside diameters of the front ring 72 and rear ring 73 are slightly smaller than the inside diameter of the rear portion of the coupling member 50. In addition, the inside diameters of the front ring 72 and rear ring 73 are slightly larger than the outer peripheral surface of the shell member 10 and smaller than the inside diameter of the spring member 71. Accordingly, as shown in FIG. 3, when the coupling member 50 is in the neutral position, the front face of the front ring 72 is supported from the front by the rear face of the front support portion 14 and the rear face of the front pressure-applying portion 56, and the rear face of the rear ring 73 is supported from the rear by the front face of the rear support portion 15 and the front face of the rear pressure-applying portion 61A.

The ball members 80, which may be, for example, metal spheres, are accommodated in the holes 11 of the shell member 10. The outside diameter of the ball members 80 is larger than the inside diameter of the radially inward openings of the holes 11, i.e., the openings formed in the inner peripheral surface of the shell member 10, and smaller than the inside diameter of the radially outward openings of the holes 11, i.e., the openings formed in the outer peripheral surface of the shell member 10. The ball members 80 have an outside diameter larger than the radially inward openings of the holes 11, and therefore enter into locked engagement with the inner peripheral edges (inner edges) of said openings from the radially outward side while having portions thereof protruding radially inwardly from the above-mentioned openings. At this time, the ball members 80 are adapted to be restricted in movement in the front-rear direction and in the circumferential direction of the shell member 10 by the inner peripheral edges of the above-mentioned openings. In the ball members 80, the portions that protrude radially inwardly from the above-mentioned openings are located within the receiving space 10D-1 of the shell member 10. In addition, as shown in FIG. 3, a clearance gap is formed between the ball members 80 and the inner surfaces of the holes 11.

In addition, as shown in FIG. 3, when the coupling member 50 is in the neutral position, the ball members 80 are supported by the protruding apical face of the intermediate protrusion 51 of the coupling member 50 from the radially outward side, which restricts radially outwardly directed movement. In addition, when the coupling member 50 is in the advanced position, the radially outward movement of the ball members 80 is permitted by the rear space 55 of the coupling member 50 (see FIG. 5 through FIG. 7), and when the coupling member 50 is in the retracted position, their radially outward movement is permitted by the front space 53 of the coupling member 50 (see FIG. 9 through FIG. 11).

First, the components of the thus configured connector main body 1A, except for the center conductor 40, are assembled in accordance with the following procedure. It should be noted that the center conductor 40 is attached to the dielectric body 30 upon connection to the front end section of the cable as described below.

First, the dielectric body 30 is attached to the shell member 10 by insertion and press-fitting from the rear. Next, the outer conductor 20 is fitted over the front portion 32 of the dielectric body 30 from the front while the rear portion 21 of the outer conductor 20 is inserted from the front between the inner peripheral surface of the positioning portion 13 of the shell member 10 and the outer peripheral surface of the front portion 32 of the dielectric body 30. The rear portion 21 of the outer conductor 20 is press-fittingly retained by the inner peripheral surface of the positioning portion 13.

Next, the rear pressure-applying member 60 is fitted over the shell member 10 from the front and is thus disposed within the bounds of the intermediate barrel portion 10B in the front-rear direction. Next, the spring member 71 is fitted over the shell member 10 from the front and is thus disposed between the front support portion 14 and the rear support portion 15 in the front-rear direction. Further, the front ring 72, which is a C-ring, is attached to the shell member 10 from the radially outward side at a location between the front support portion 14 and the spring member 71 in the front-rear direction. In addition, the rear ring 73, which is a C-ring, is attached to the shell member 10 from the radially outward side at a location between the rear support portion 15 and the spring member 71 in the front-rear direction.

Next, the ball members 80 are accommodated in each hole 11 of the shell member 10 from the radially outward side of said shell member 10. Next, the coupling member 50 is attached by fitting over the shell member 10 from the front. Further, the tubular portion 61 of the rear pressure-applying member 60 is inserted into the clearance gap between the outer peripheral surface of the intermediate barrel portion 10B of the shell member 10 and the inner peripheral surface of the rear end portion of the coupling member 50 from the rear, which press-fittingly retains the tubular portion 61 in the rear end portion of the coupling member 50. This completes the assembly of the connector main body 1A (except for the center conductor 40).

Upon completion of assembly of the connector main body 1A (except for the center conductor 40), the front support portion 14 of the shell member 10 and the front pressure-applying portion 56 of the coupling member 50 support the front ring 72 from the front, and the rear support portion 15 of the shell member 10 and the rear pressure-applying portion 61A of the rear pressure-applying member 60 support the rear ring 73 from the rear. Accordingly, a condition results wherein the front support portion 14 and front pressure-applying portion 56 support the spring member 71 from the front through the medium of the front ring 72, and the rear support portion 15 and rear pressure-applying portion 61A support the spring member 71 from the rear through the medium of the rear ring 73. The spring member 71 maintains the coupling member 50 in the neutral position illustrated in FIG. 3 in the front-rear direction using reaction forces (resilient forces) counteracting the supporting forces acting from the front and from the rear. Namely, the spring member 71 applies resilient forces adapted to bring the coupling member 50 to the neutral position to the front pressure-applying portion 56 and the rear pressure-applying portion 61A.

In addition, the coupling member 50 is in the neutral position and therefore, as shown in FIG. 3, the intermediate protrusion 51 of the coupling member 50 supports the ball members 80 from the radially outward side of the shell member 10 and restricts radially outwardly directed movement of the ball members 80. In addition, in this state the inner peripheral edges of the openings of the holes 11 formed in the inner peripheral surface of the shell member 10 restrict the movement of the ball members 80 in the front-rear direction as well as in the circumferential direction of the shell member 10.

As shown in FIG. 3, the cable attachment portion 1B has a clamp 90, a rubber ring 100, a washer 110, and a fastening fitting 120. The clamp 90, rubber ring 100, washer 110, and fastening fitting 120, which are disposed adjacently in that order from the front, are accommodated within the rear interior space 10F of the shell member 10, with the exception of the rear portion of the fastening fitting 120. The respective interior spaces of the clamp 90, rubber ring 100, washer 110, and fastening fitting 120, which are in communication in the front-rear direction, allow for insertion of the front end section of the cable (not shown) therethrough from the rear.

The clamp 90 is metal member of a generally tubular shape extending in the front-rear direction. The front portion of the clamp 90 has an outer peripheral surface tapered along the inner peripheral surface of the front portion of the rear barrel portion 10C. Specifically, said outer peripheral surface is inclined such that its outside diameter is reduced as one moves forward. The inner peripheral surface of the clamp 90 has a stepped portion 91 formed at the location of the boundary between the front portion and rear portion. As a result, the interior space of the rear portion of the clamp 90 has a larger diameter than the interior space of the front portion. The clamp 90 has the front face thereof disposed in surface contact with the rear face of the intervening ring 130.

The rubber ring 100, which is a rubber member of an annular configuration, has the front face thereof disposed in surface contact with the rear face of the clamp 90. The inside diameter of the rubber ring 100 is slightly smaller than the inside diameter of the rear portion of the clamp 90. The washer 110, which is a metal member of an annular plate-like configuration, has the front face thereof disposed in surface contact with the rear face of the rubber ring 100. The inside diameter of the washer 110 is substantially the same as the inside diameter of the rear portion of the clamp 90.

The fastening fitting 120 is metal member of a generally tubular shape extending in the front-rear direction. Thread ridges (not shown) are formed on the outer peripheral surface of the front portion of the fastening fitting 120. The fastening fitting 120 is attached to the shell member 10 by threadedly mating said thread ridges with screw grooves (not shown) in the inner peripheral surface of the shell member 10. As shown in FIG. 3, once the fastening fitting 120 is attached to the shell member 10, the front face is placed in surface contact with the rear face of the washer 110.

As shown in FIG. 3, the intervening ring 130 and the intervening washer 140 are accommodated in the intermediate interior space 10E of the shell member 10. The intervening ring 130, which is a metal member of a toroidal configuration formed of an outside diameter that is substantially the same as the inside diameter of the shell member 10 at the location of the intermediate interior space 10E, is placed in contact with the inner peripheral surface of the shell member 10 via the outer peripheral surface thereof. In addition, the front face of the intervening ring 130 is in surface contact with the rear face of the stepped portion 12 of the shell member 10 and the rear face of the dielectric body 30.

The intervening washer 140 is a rubber member of a toroidal configuration. As shown in FIG. 3, the intervening washer 140, which is formed of an outside diameter that is substantially the same as the inside diameter of the intervening ring 130 and, in addition, is formed of substantially the same dimensions in the front-rear direction as the intervening ring 130, is accommodated in the interior space of the intervening ring 130. The front face of the intervening washer 140 is in surface contact with the rear face of the dielectric body 30. In addition, the inside diameter of the intervening washer 140 is slightly smaller than the inside diameter of the connecting portion 41 of the center conductor 40. The interior space of the connecting portion 41 and the interior space of the cable attachment portion 1B are placed in communication through the medium of the interior space of the intervening washer 140.

The cable attachment portion 1B, fastening fitting 120, washer 110, rubber ring 100, and clamp 90 are attached, in that order, to the front end section of the cable by fitting thereover from the front. At this time, the cable's jacket (not shown) is retained in the radial direction by the inner peripheral surfaces of the rear portion of the clamp 90, rubber ring 100, washer 110, and front portion of the fastening fitting 120. In addition, a shielding layer (not shown) exposed from the jacket of the cable is retained in the radial direction by the inner peripheral surface of the front portion of the clamp 90. In addition, the front end of the cable's jacket abuts a stepped portion 91 in the clamp 90 from the rear, thereby positioning said cable in the front-rear direction.

The front end section of the cable to which the cable attachment portion 1B is attached is connected to the connector main body 1A in accordance with the following procedure. First, the core wire exposed in the front end section of the cable is inserted into the interior space of the connecting portion 41 of the center conductor 40 and, in addition, connected to said connecting portion 41 by soldering, crimping, or the like. Next, the intervening ring 130 is fitted and accommodated within the intermediate interior space 10E of the shell member 10 from the rear. Next, the intervening washer 140 is fitted into and accommodated within in the interior space of the intervening ring 130 from the rear. Next, the front end section of the cable to which the center conductor 40 is connected, along with the cable attachment portion 1B, is fitted within the connector main body 1A (except for the center conductor 40) from the rear, and the front portion of the fastening fitting 120 is attached to the rear portion of the shell member 10 via threaded mating. In addition, at this time, the center conductor 40 is fitted into the dielectric body 30 from the rear and press-fitted therein.

Once the cable attachment portion 1B is attached to the connector main body 1A, the front face of the clamp 90 is placed in contact with the intervening ring 130. In addition, the intervening ring 130 is placed in contact with the shell member 10 via the outer peripheral surface and front face thereof. Accordingly, the cable's shielding layer is brought into a state permitting electrical communication with the shell member 10 through the medium of the clamp 90 and intervening ring 130.

As shown in FIG. 3, the counterpart connector 2 has a counterpart outer conductor 150, a counterpart dielectric body 160, a counterpart center conductor 170, and a stop ring 180. The counterpart outer conductor 150, counterpart dielectric body 160, counterpart center conductor 170, and stop ring 180 have the same axis extending in the front-rear direction and are provided concentrically along said axis.

The counterpart outer conductor 150, which is a metal member, has a plate-shaped base portion 151 disposed at right angles to the front-rear direction and a generally cylindrical tubular portion 152 extending rearwardly (in the X2 direction) from the rear face of the base portion 151.

As shown in FIG. 1 and FIG. 2, the base portion 151 is a plate-shaped part that has an outer shape of a substantially quadrangular configuration when viewed in the front-rear direction. One attachment hole 151A, i.e., a screw hole passing through the base portion 151 in the front-rear direction, is formed in each corner of the base portion 151. In the present embodiment, screw members (not shown) are threadably mated with the attachment holes 151A and with screw holes (not shown) provided in the housing of the electronic device in alignment with said attachment holes 151A from the rear, thereby attaching the counterpart connector 2 to the above-mentioned housing.

The rear portion of the tubular portion 152, i.e., the part located rearwardly of the hereinafter described positioning protrusion 152B, serves as a counterpart outer mating portion 152A used for mating with the connector 1. The interior space of the counterpart outer mating portion 152A is formed as a counterpart receiving space 153 used for receiving a portion of the connector 1 from the rear.

In the counterpart outer mating portion 152A, there is formed a ring groove-shaped locking engagement portion 152A-1 that is recessed into the outer peripheral surface while extending throughout the entire circumference at a location proximate to the rear end. As shown in FIG. 3, the inner surface of the locking engagement portion 152A-1 on the forward side (the X1 side) is an inclined surface inclined forward as one moves inwardly in the radial direction of the counterpart outer mating portion 152A. The inner surface of the locking engagement portion 152A-1 on the rearward side (the X2 side) is an inclined surface inclined rearwardly as one moves inwardly in the radial direction of the counterpart outer mating portion 152A. In a state of mated connection of the two connectors, the locking engagement portion 152A-1 is capable of receiving portions of the ball members 80 of the connector 1 and lockingly engaging said portions in the front-rear direction (see FIG. 8).

As shown in FIG. 3, in the tubular portion 152, at an intermediate location in the front-rear direction, specifically, at the location of the boundary between the front portion and rear portion, there is formed a positioning protrusion 152B protruding from the inner peripheral surface while extending throughout the entire circumference. The positioning protrusion 152B is a part that positions the counterpart dielectric body 160 in the front-rear direction. In addition, as shown in FIG. 3, a stepped portion 152C is formed in the inner peripheral surface of the tubular portion 152 at a location proximate to the front end. As a result, in the tubular portion 152, the interior space of the front end portion (the part located forwardly of the stepped portion 152C) is larger in the radial direction than the interior space of other portions.

The counterpart dielectric body 160 is a member made of plastic or another electrically insulating material having a generally tubular shape extending in the front-rear direction. It has an intermediate barrel portion 161 serving as an intermediate portion in the front-rear direction, a counterpart inner mating portion 162 extending rearwardly from the intermediate barrel portion 161, and a projecting portion 163 extending forwardly from the intermediate barrel portion 161. The intermediate barrel portion 161 is accommodated in the interior space of the front portion of the tubular portion 152. As shown in FIG. 3, the rear end portion of the intermediate barrel portion 161 has a slightly smaller diameter than other portions and has a stepped portion 161A formed at the location of the boundary between the above-mentioned rear end portion and the above-mentioned other portions.

The counterpart inner mating portion 162 has a smaller diameter than the intermediate barrel portion 161. The counterpart inner mating portion 162, which is a part used for mating with the connector 1, is accommodated within the interior space of the counterpart outer mating portion 152A, that is, within the counterpart receiving space 153. The projecting portion 163, which extends forward of the front face of the base portion 151, is located external to the counterpart outer conductor 150.

The counterpart center conductor 170, which is a metal member extending in the front-rear direction, is retained by the counterpart dielectric body 160. The counterpart center conductor 170 has a counterpart connecting portion 171 provided at the front end, a counterpart contact portion 172 provided at the rear end, and a counterpart joining portion 173 provided at an intermediate location and joining the counterpart connecting portion 171 and the counterpart contact portion 172. The counterpart connecting portion 171, which extends forward of the front face of the counterpart dielectric body 160, is located external to the counterpart dielectric body 160. The counterpart contact portion 172 is accommodated in the interior space of the counterpart inner mating portion 162, and the counterpart joining portion 173 is accommodated in the interior space of the intermediate barrel portion 161 and projecting portion 163.

The counterpart connecting portion 171, which is solid, is connectable to corresponding circuitry (not shown) provided in the electronic device. The counterpart contact portion 172, which is a hollow female contact portion, is capable of receiving the contact portion 42 of the center conductor 40 provided in the connector 1 from the rear and making contact with said contact portion 42 (see FIG. 8). The counterpart joining portion 173, which is solid, is press-fitted into the intermediate barrel portion 161 and projecting portion 163 of the counterpart dielectric body 160. As a result, the counterpart center conductor 170 is retained by the counterpart dielectric body 160.

As shown in FIG. 3, a forwardly open ring groove-shaped end recess 2A is formed in the counterpart outer conductor 150 and counterpart dielectric body 160 by recessing, respectively, the inner peripheral surface of the front end portion of the tubular portion 152 and the outer peripheral surface of the front end portion of the intermediate barrel portion 161 in the radial direction. The stop ring 180, which is a metal annular member, is accommodated and retained by press-fitting in the end recess 2A from the front.

The thus configured counterpart connector 2 is assembled in accordance with the following procedure. First, the counterpart dielectric body 160 is fitted within the interior space of the counterpart outer conductor 150 from the front. Next, the stop ring 180 is fitted over the counterpart dielectric body 160 from the rear while being press-fitted into the end recess 2A from the rear. At this time, the stop ring 180 abuts, from the front, the inner surfaces of the end recess 2A, that is, the stepped portion 152C of the counterpart outer conductor 150 and the stepped portion 161A of the counterpart dielectric body 160. As a result, the stepped portion 161A becomes lockingly engaged with the stop ring 180 from the rear, and decoupling of the counterpart dielectric body 160 from the counterpart outer conductor 150 is prevented. Next, the counterpart center conductor 170 is caused to be retained in the counterpart dielectric body 160 by press-fitting from the front. This completes the assembly of the counterpart connector 2.

The operation of mating connection of the connector 1 and counterpart connector 2 will be described next. It should be noted that, as far as the movement of the ball members 80 in the process of mating connection is concerned, the discussion will focus primarily on the ball members 80 located at the top in FIG. 3.

First, the front end section of the cable (not shown) is connected to the connector 1 and, in addition, the counterpart connector 2 is threadably attached to the housing of the electronic device. Next, as shown in FIG. 1 through FIG. 3, the connector 1 is positioned at the rear of the counterpart connector 2. Specifically, the connector 1 is positioned along the same axis as the counterpart connector 2 such that the receiving space 10D-1 of the connector 1 is in a face-to-face relationship with the counterpart receiving space 153 of the counterpart connector 2.

Next, the connector 1 is mated with the counterpart connector 2 by moving it in the forward direction while holding the coupling member 50 with one's fingers. At this time, the counterpart outer mating portion 152A and counterpart inner mating portion 162 of the counterpart connector 2 are received in the receiving space 10D-1 of the connector 1 from the front. In addition, the inner mating portion 32A of the connector 1 enters the counterpart receiving space 153 of the counterpart connector 2 from the rear.

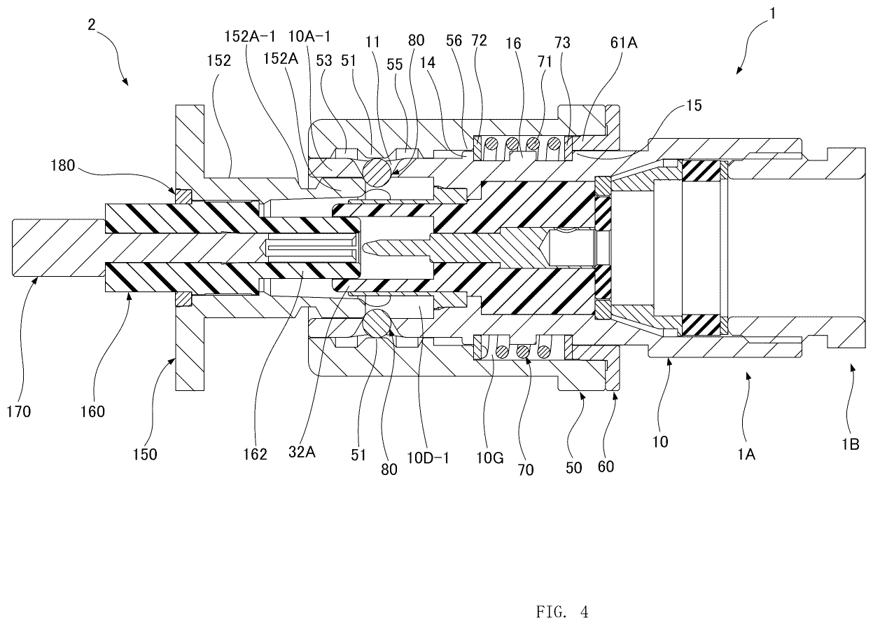

When the operation of mating connection is initiated, first, as shown in FIG. 4, the rear end portion of the counterpart outer mating portion 152A of the counterpart connector 2 abuts, from the front, a portion of the ball members 80 of the connector 1, specifically, the part protruding into the receiving space 10D-1 from the holes 11. At this time, the coupling member 50 is in the neutral position, and the ball members 80 are therefore restricted in movement in the front-rear direction and in the circumferential direction of the shell member 10 by the inner peripheral edges of the holes 11 while being restricted in radially outward movement by the intermediate protrusion 51 of the coupling member 50. Accordingly, as shown in FIG. 5, with the rear end portion of the counterpart outer mating portion 152A kept in abutment against the ball members 80 from the front, the coupling member 50 and rear pressure-applying member 60 effect relative movement with respect to the shell member 10 in the forward direction, and the coupling member 50 is brought to the advanced position. At this time, in the resilient body 70, the rear ring 73 is subjected to pressure by the rear pressure-applying portion 61A of the rear pressure-applying member 60 from the rear while the front ring 72 is supported by the front support portion 14 of the shell member 10 from the front, as a result of which the spring member 71 is brought into a fully compressed state.

As shown in FIG. 5, when the coupling member 50 is in the advanced position, the abutment portion 16 of the coupling member 50, via the rear face thereof, is placed in surface contact with the front face of the rear ring 73 of the resilient body 70 and abuts said rear ring 73 from the front. Accordingly, the extent of compression of the spring member 71 in the front-rear direction and, in turn, the extent of forward movement of the coupling member 50, can be kept within a predetermined range. As a result, the operating range of the connector 1 in the front-rear direction during mating connection of the connectors can be reduced.

As shown in FIG. 5, when the coupling member 50 is brought to the advanced position, the rear space 55 of the coupling member 50 is positioned in alignment with the ball members 80 in the front-rear direction. Specifically, the rear space 55 is positioned to include the ball members 80 in the front-rear direction. Accordingly, radially outwardly directed movement of the ball members 80 is permitted by the rear space 55. It should be noted that at this time, as shown in FIG. 5, the ball members 80 located at the bottom move downwardly by gravity and have portions thereof protruding into the rear space 55. At this time, the ball member 80 does not protrude inwardly in the radial direction.

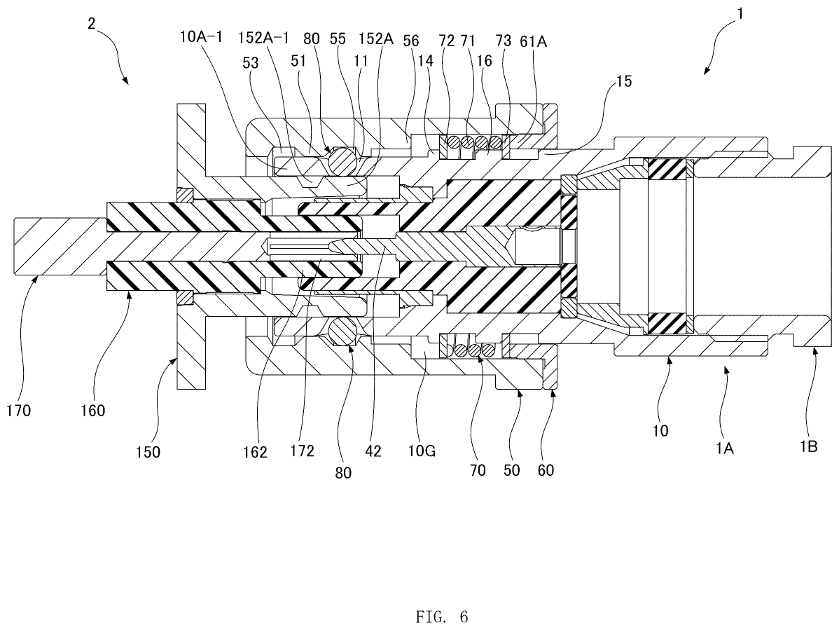

Next, as shown in FIG. 6, the ball members 80, pressed against the rear end portion of the counterpart outer mating portion 152A of the counterpart connector 2, move outwardly in the radial direction, thereby making advancement of the connector 1 possible. At this time, the ball members 80 are supported by the rear end portion of the counterpart outer mating portion 152A from the radially inward side and therefore do not protrude radially inwardly from the holes 11. On the other hand, a portion of the ball members 80 protrudes radially outwardly from the holes 11 and is located within the rear space 55. In addition, at this time, as shown in FIG. 6, the contact portion 42 of the connector 1 starts entering the counterpart contact portion 172 of the counterpart connector 2.

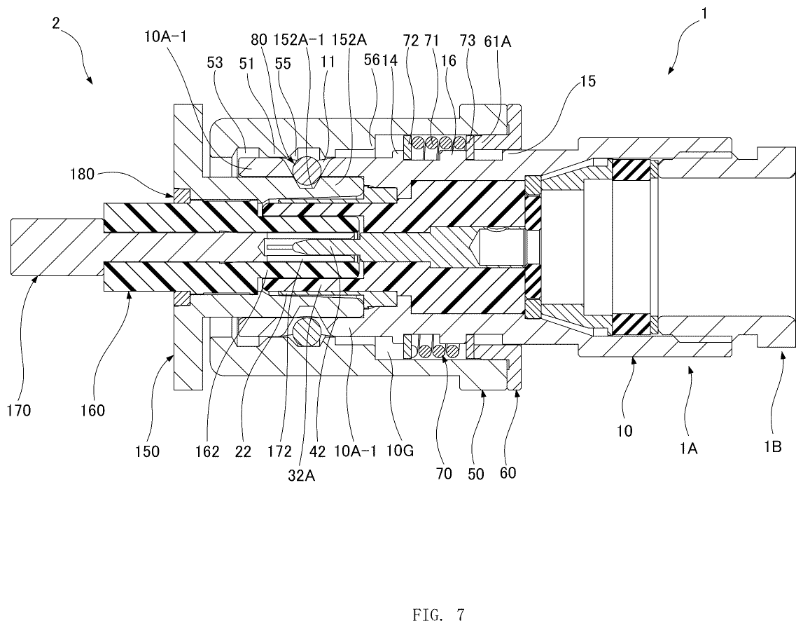

As shown in FIG. 7, when the connector 1 advances further and reaches the standard mating position, the locking engagement portion 152A-1 of the counterpart connector 2 is positioned in alignment with the ball members 80 in the front-rear direction. Specifically, the locking engagement portion 152A-1 is brought into communication with the holes 11 in the radial direction. As a result, the ball members 80 move radially inwardly by gravity and portions thereof protrude from the holes 11. The protruding portions of the ball members 80 are accommodated in the locking engagement portion 152A-1 and lockingly engage the inner surface of the locking engagement portion 152A-1 in the front-rear direction.

In addition, as shown in FIG. 7, in the standard mating position, the contact portion 42 of the connector 1 enters the interior of the counterpart contact portion 172 of the counterpart connector 2 and makes contact with the counterpart contact portion 172 in the radial direction under contact pressure. As a result, the center conductor 40 and counterpart center conductor 170 are brought into electrical communication. In addition, the counterpart outer mating portion 152A of the counterpart outer conductor 150 of the counterpart connector 2 enters the interior of the receiving space 10D-1 of the connector 1 and makes contact with the outer mating portion 10A-1 of the shell member 10 and the front portion 22 of the outer conductor 20 in the radial direction under contact pressure. As a result, the shell member 10 and outer conductor 20 are brought into electrical communication with the counterpart outer conductor 150.

Next, when one's fingers are removed from the coupling member 50, the spring member 71 of the resilient body 70 is released from the fully compressed state, as a result of which, as shown in FIG. 8, the coupling member 50 and rear pressure-applying member 60 move rearwardly under the resilient force (restoring force) of the spring member 71, and the coupling member 50 is returned to the neutral position. This movement of the coupling member 50 and rear pressure-applying member 60 is relative movement with respect to the shell member 10. When the coupling member 50 is returned to the neutral position, radially outwardly directed movement of the ball members 80 is restricted by the intermediate protrusion 51 of the coupling member 50. As a result, the locked engagement of the protruding portions of the ball members 80 (the parts protruding from the holes 11 inwardly in the radial direction) and locking engagement portion 152A-1 is maintained, and inadvertent decoupling of the two connectors is prevented. This completes the operation of mating connection of the two connectors.

The operation of decoupling of the two connectors will be described next. When decoupling the connector 1 from the counterpart connector 2, the connector 1 is pulled rearwardly while the coupling member 50 of the connector 1 is held with one's fingers, etc. In a state of mated connection, the protruding portions of the ball members 80 and locking engagement portion 152A-1 are in locked engagement as described above. Accordingly, when the decoupling operation is initiated, first, the coupling member 50 is brought to the retracted position via relative movement of the coupling member 50 and rear pressure-applying member 60 with respect to the shell member 10 in the rearward direction. As a result, as shown in FIG. 9, the front space 53 is positioned in alignment with the ball members 80 in the front-rear direction. Specifically, the front space 53 is positioned to include the ball members 80 in the front-rear direction. Accordingly, radially outwardly directed movement of the ball members 80 is permitted by the front space 53.

In addition, when the coupling member 50 is brought to the retracted position, in the resilient body 70, the front ring 72 is subjected to pressure by the front pressure-applying portion 56 of the coupling member 50 from the front while the rear ring 73 is supported by the rear support portion 15 of the shell member 10 from the rear, and the spring member 71 is thus compressed to the full extent.

As shown in FIG. 9, when the coupling member 50 is in the retracted position, the abutment portion 16 of the coupling member 50, via the front face thereof, is placed in surface contact with the rear face of the front ring 72 of the resilient body 70 and abuts said front ring 72 from the rear. Accordingly, the extent of compression of the spring member 71 in the front-rear direction and, in turn, the extent of rearward movement of the coupling member 50, can be kept within a predetermined range. As a result, the operating range of the connector 1 in the front-rear direction during connector decoupling can be reduced.

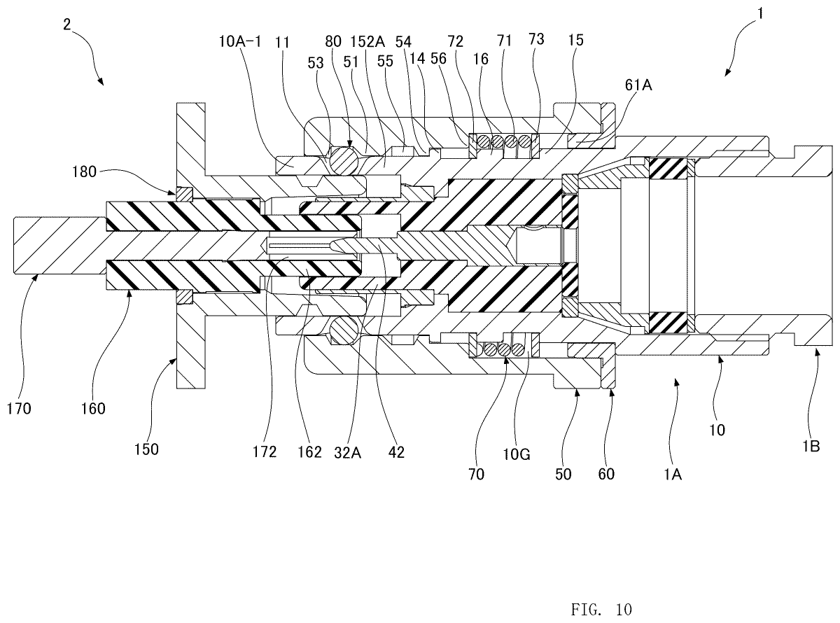

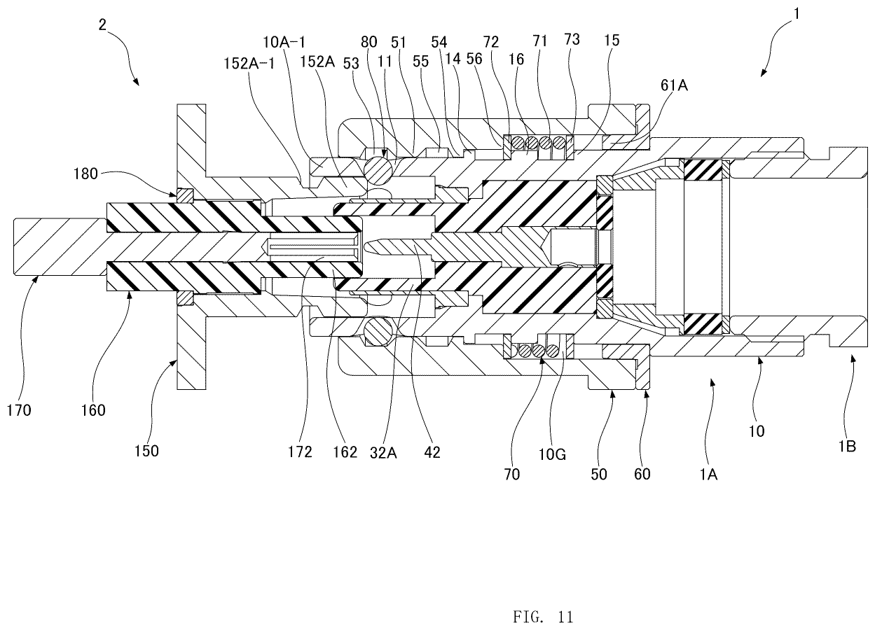

In the present embodiment, the rear inner surface of the locking engagement portion 152A-1 is an inclined surface inclined forward as one moves inwardly in the radial direction. Accordingly, when the connector 1 is pulled rearward, the protruding portions of the ball members 80 are subject to forces directed forwardly and radially outwardly from the above-mentioned rear inner surface (inclined surface). As shown in FIG. 10, the ball members 80 then move outwardly in the radial direction under the action of the above-mentioned radially outwardly directed force. As a result, the ball members 80 and locking engagement portion 152A-1 are released from locked engagement, which makes further rearward movement of the connector 1 possible. As shown in FIG. 11, the connector 1 is then pulled rearward “as-is,” thereby decoupling the connector 1 from the counterpart connector 2 and completing the operation of decoupling.

Thus, in the present embodiment, during the operation of mating connection and the operation of decoupling of the two connectors, the ball members 80 are adapted to move in the radial direction alone, without moving in the front-rear direction with respect to the shell member 10. Accordingly, there is no need to form the holes of a shape elongated in the front-rear direction to permit movement of the ball members in the front-rear direction, as was done in the prior art, and an increase in the size of the shell member and, by extension, the connector, in the front-rear direction can therefore be avoided better than in the prior art.

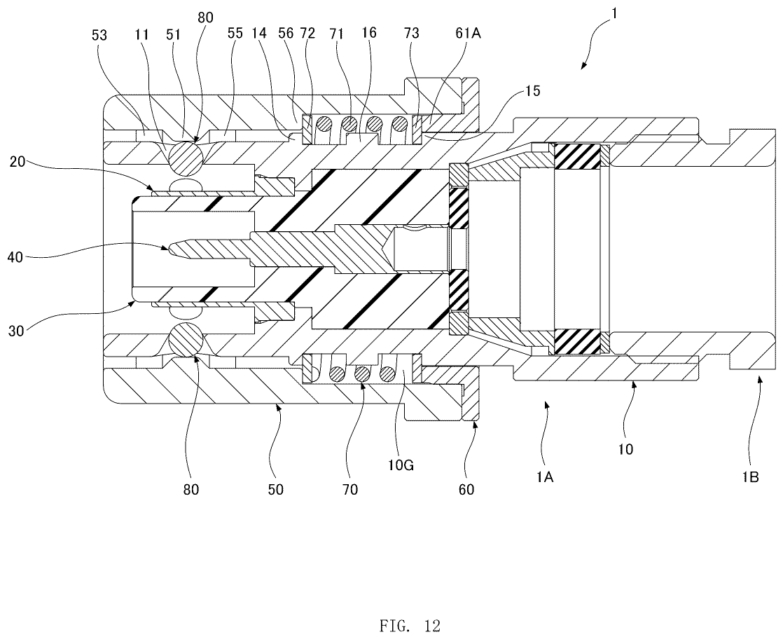

Although in the previously discussed embodiment a front protrusion 52 and a rear protrusion 54 were provided in the coupling member 50, as a variation, it is also possible to eliminate the front protrusion 52 and the rear protrusion 54. Accordingly, in this variation, as shown in FIG. 12, the front space 53 opens forwardly and the rear space 55 opens rearwardly, which makes the configuration different from the previously discussed embodiment. In this variation, similarly to the previously discussed embodiment, when the coupling member 50 is in the advanced position, radially outward movement of the ball members 80 is permitted by the rear space 55, and when the coupling member 50 is in the retracted position, radially outward movement of the ball members 80 is permitted by the front space 53.

While in the previously discussed embodiment the movement of the ball members 80 in the front-rear and circumferential directions was restricted by the inner peripheral edges of the holes 11 of the shell member 10, as a substitute variation, the movement of the ball members 80 in the front-rear and circumferential directions may be restricted, for example, by the inner surfaces of the holes. In this variation, at least a portion of the inner surface of the holes is formed of a shape permitting surface contact with the outer surface of the ball members.

While in the previously discussed embodiment the rear pressure-applying portion 61A was provided in the rear pressure-applying member 60, which was separate from the coupling member 50, as a variation, the rear pressure-applying portion may be provided in a portion of the coupling member. At this time, the rear pressure-applying portion may be provided, for example, in the rear end portion of the coupling member. In this variation, there is no longer need to additionally provide a member separate from the coupling member in order to also provide a rear pressure-applying portion, and the number of parts can therefore be reduced.

While in the previously discussed embodiment the coupling member was held with one's fingers during the operation of mating connection and the operation of decoupling of the two connectors, as an alternative, the coupling member may be configured to be held, for instance, using a jig or the like.

### DESCRIPTION OF THE REFERENCE NUMERALS

1 Connector
2 Counterpart connector
10 Shell member
10G Accommodating space
11 Holes
14 Front support portion
15 Rear support portion
16 Abutment portion
20 Outer conductor
30 Dielectric body
40 Center conductor
50 Coupling member
51 Intermediate protrusion (protrusion)
53 Front space
55 Rear space
56 Front pressure-applying portion
60 Rear pressure-applying member
61A Rear pressure-applying portion
70 Resilient body
80 Ball members
152A-1 Locking engagement portion

What is claimed is:

1. A coaxial electrical connector having an axis extending in the front-rear direction and matingly connected to a counterpart connector in the forward direction, the coaxial electrical connector comprising:
a shell member having a tubular shape extending in the front-rear direction and having at least one hole formed passing therethrough in the radial direction,
an outer conductor, a dielectric body, and a center conductor provided within the shell member, a coupling member fitted over the shell member and capable of relative movement with respect to the shell member in the front-rear direction between an advanced position and a retracted position, and
ball members accommodated in the holes,
wherein said coaxial electrical connector has a resilient body which is accommodated in an accommodating space formed between the outer peripheral surface of the shell member and the inner peripheral surface of the coupling member at a location different from the ball members in the front-rear direction, and which is capable of expansion and compression in the front-rear direction,
a front support portion capable of supporting the resilient body from the front and a rear support portion capable of supporting the resilient body from the rear, which are provided in the shell member,
a front pressure-applying portion capable of applying pressure to the resilient body from the front and a rear pressure-applying portion capable of applying pressure to the resilient body from the rear, which are provided in the coupling member,
and wherein
the resilient body is capable of applying a resilient force adapted to bring the coupling member to a neutral position between the advanced position and the retracted position to the front pressure-applying portion and rear pressure-applying portion,
the coupling member has a protrusion protruding from the inner peripheral surface of said coupling member and forms a front space forwardly of the protrusion between itself and the outer peripheral surface of the shell member while forming a rear space rearwardly of the protrusion between itself and the outer peripheral surface of the shell member,
the ball members are restricted in movement in the front-rear direction by the inner edges or inner surfaces of the holes while being movable in the radial direction, and are lockingly engageable with a locking engagement portion provided in the counterpart connector via portions protruding radially inwardly from the holes, and
when the coupling member is in the neutral position, the protrusion is positioned in alignment with the ball members in the front-rear direction, which restricts radially outwardly directed movement of the ball members,
when the coupling member is in the advanced position, the rear space is positioned in alignment with the ball members in the front-rear direction, which permits radially outwardly directed movement of the ball members, and
when the coupling member is in the retracted position, the front space is positioned in alignment with the ball members in the front-rear direction, which permits radially outwardly directed movement of the ball members.

2. The coaxial electrical connector according to claim 1, wherein, when the coupling member is in the neutral position, the front support portion and front pressure-applying portion have both rear faces thereof aligned in the front-rear direction and make contact with the resilient body from the front via the respective rear faces, and the rear support portion and the rear pressure-applying portion have both front faces thereof aligned in the front-rear direction and make contact with the resilient body from the rear via the respective front faces.

3. The coaxial electrical connector according to claim 1, wherein the shell member has an abutment portion protruding from the outer peripheral surface of the shell member within the bounds of the accommodating space in the front-rear direction, and
the abutment portion abuts the rear portion of the resilient body subjected to pressure by the rear pressure-applying portion from the front when the coupling member is in the advanced position, and abuts the front portion of the resilient body subjected to pressure by the front pressure-applying portion from the rear when the coupling member is in the retracted position.

4. The coaxial electrical connector according to claim 1, wherein the rear pressure-applying portion is provided in a member that is fitted over the shell member while being attached to the coupling member from the rear.

5. The coaxial electrical connector according to claim 1, wherein the front end of the shell member is aligned with the front end of the coupling member or located rearwardly of said front end when said coupling member is in the neutral position.

6. An electrical connector assembly characterized by having a coaxial electrical connector according to claim 1, and a counterpart connector matingly connected to said coaxial electrical connector.
